(19) United States
(12) Patent Application Publication
(10) Pub. No.: US 2013/0012374 A1
(43) Pub. Date: Jan. 10, 2013

(54) PACKAGE FOR THE STORAGE OF WASTE

(75) Inventors: Milan Hrovat, Rodenbach (DE); Richard Seemann, Hanau (DE); Karl-Heinz Grosse, Grundau (DE)

(73) Assignee: ALD VACUUM TECHNOLOGIES GMBH, Hanau (DE)

(21) Appl. No.: 13/637,077

(22) PCT Filed: Mar. 24, 2011
(86) PCT No.: PCT/EP2011/054549

§ 371 Date: Sep. 25, 2012

(30) Foreign Application Priority Data
Mar. 25, 2010 (DE) 10 2010 003 289.1

(51) Int. Cl. G21F 9/00; C03C 14/00

(52) U.S. Cl. 501/32; 588/16

(57) ABSTRACT

A package for storing radioactive waste, which is suitable for safe, ultra-long ultimate disposal having a moisture-impermeable, corrosion-resistant graphite matrix and metal-encased waste products, which are embedded into the matrix. A method for producing such packages is also part of the invention.

### FIELD OF THE INVENTION

This invention relates to a package for the storage of waste, which is suitable for ultra-long safe ultimate disposal, having a moisture-impermeable, corrosion-resistant graphite matrix and at least one waste compartment which is embedded into the matrix. Furthermore, a method for producing the packages and their use are described.

### BACKGROUND OF THE INVENTION

The term “waste” refers to any kind of waste; preferably waste that emits radioactive radiation and that contains fission and decay products, respectively. This invention is particularly suitable for the ultimate disposal of waste with high level radioactivity, so called High Level Waste (HLW). This is for example the waste, which accrues with the reprocessing of spent nuclear fuel elements. Besides, spent nuclear fuel elements that are not reprocessed are classified as HLW among others.

In Europe alone, there are currently about 8000 cubic meters HLW from reprocessing plants in intermediate-storage facilities. Each year, approximately 280 cubic meters are added. All currently available materials and procedures for the inclusion of such HLW-waste are not suitable for ultimate disposal so far.

With the reprocessing of spent nuclear fuel elements for example from a light water reactor having a power of 1000 MWe, 720 kg of waste with high level radioactivity accrue each year. After the nuclear fuel reprocessing the waste is in the form of a liquid and is usually converted into a solid form by calcination. Unfortunately, the decay heat and the half life periods of the single radionuclides differ from each other by several decimal powers.

For conditioning and storage of HLW a series of methods have been developed with the intention to meet the requirements of an ultimate disposal site.

To ensure safe ultra-long ultimate disposal of HLW, high demands are placed on the packages with regard to the corrosion resistance of the containers such that a penetration of moisture and a resulting corrosion, caused by the radiolysis, can be largely excluded in spite of the radioactive radiation and temperatures above 100° C. Still further, it is required that the mobility of the radionuclides by diffusion processes is as low as possible.

At present, the method for producing HLW-containing glass-blocks is the most developed. The HLW arising from the reprocessing facility is preferably melted down in borosilicate glass and the produced glass blocks are introduced into stainless steel containers and consequently, represent the waste package.

The vitrification of HLW-blocks is already carried out in the production scale. For this, production facilities in Marcoule and La Hague, France, were built among others, which are in operation since 1970.

The outer steel containers are both corrosion protection layer as well as diffusion barrier for radionuclides. The corrosion resistance of the containers particularly depends on the type of container, the moisture hat is present and the associated radiolysis at temperatures above 100° C.

The drawback of all HLW-containing components surrounded by an outer metal container is the limited corrosion resistance of the metal containers. This is due to the fact that the metallic materials that are available up to now for producing containers have an expected maximum of corrosion resistance of at most about 10,000 years. Consequently, a safe entombment of the radioactive wastes beyond this period cannot be guaranteed. Moreover, the removal of decay heat from the known packages is hampered by the low thermal conductivity.

Methods which include the coating of small HLW-particles have not been successful. This is due to the aggravated production conditions during the hot cell operation in the coating of the sintered waste particles in turbulent fluidized bed plants in connection with a high demand for carrier gases (up to 20 m³/hour), followed by the difficult and laborious conditioning of the particles. A further reason is the expensive disposal of the carrier gas.

in Germany it is intended to entomb packages loaded with HLW in salt rock boreholes or caverns and to seal the same after entombment with salt materials (“Salzgruβ”) or salt concrete. A consent agreement on this concept has, however, not been found so far. Once again, an evaluation of potential disposal sites in Germany is carried out since 2002.

The steel containers according to the prior art have the function of avoiding corrosion of the steel container as well as of preventing the diffusion of the radionuclides from the HLW-containing components such as glass blocks.

As the corrosion resistance of the outer steel containers is limited to at most 10,000 years according to the current state of the art, a safe inclusion of the radionuclides beyond this period cannot be guaranteed.

### SUMMARY OF THE INVENTION

Thus, it is the object of the invention to provide packages for the storage of waste, which allow for an safe ultra-long ultimate disposal of such waste and can be produced cost-effectively.

The object is solved by the subject-matter of the patent claims.

The packages according to the present invention comprise a matrix and waste compartments embedded into this matrix. The waste compartments preferably comprise waste-containing composite-pressed elements (e.g. rods), which are seamlessly surrounded by a metallic shell. Thus, the waste compartments preferably have waste products in a metallic shell. The waste products can be mixed with a binder, which is preferably glass. The matrix comprises graphite and glass as inorganic binder.

The waste products can preferably be selected from spent nuclear fuel elements.

Using the term “waste products” in this specification implies that said waste is usually a mixture of several products. In accordance with the present invention, the term, however, also covers products that consist of a single component.

The package is characterized by an inverse configuration (inverse design). In contrast to the already known packages with glass blocks which are surrounded by an outer steel container, the waste compartments of the waste packages according to the present invention are embedded into a corrosion-resistant, moisture-impermeable glass-graphite-matrix (impermeable Graphite-Glass-Matrix, IGG-Matrix). In this context, it is essential that the function of the outer steel container is shifted into the inner package area by the metal shell of the waste products, hence “inverse design”.

The requirements to prevent corrosion as well as diffusion of the radionuclides are met apart from each other in the packages according to the present invention. The IGG-Matrix is preferably free of pores and has a high density, which is close to the theoretical density, and is, thus, moisture-impermeable and corrosion-resistant. The inner metal shell acts as a diffusion barrier.

Due to the high corrosion resistance of the IGG-Matrix on the one hand and the intact metal shell of the embedded waste in the inner area of the package on the other hand, any release of radionuclides into the biosphere from the packages which are finally disposed is prevented for an ultra-long time frame (more than 1 million of years).

According to the present invention, an impermeable and corrosion-resistant graphite matrix with glass as inorganic binder has been developed for the integration of waste.

Graphite is a material, which is known to have a high corrosion resistance as well as stability against radiation. This is already confirmed for the natural graphite being present in unchanged form in the nature for millions of years.

The portion of graphite in the matrix preferably amounts to 60 to 90% by weight. It is preferred that the graphite is natural graphite or synthetic graphite or a mixture) of both components. It is especially preferred that the graphite portion in the matrix material according to the present invention consists of 60% by weight to 100% by weight of natural graphite and 0% by weight to 40% by weight of synthetic graphite. The synthetic graphite can also be referred to as graphitized electrographite powder.

Natural graphite has the advantage that it is well-priced, that the graphite grain has no nano-cracks and that it can be compressed into molded bodies with nearly theoretical density by applying moderate pressure.

The glass which is used as binder according to the present invention is preferably borosilicate glass. The advantage of borosilicate glasses is their good corrosion stability. Borosilicate glasses are glasses with high chemical and temperature resistance. The good chemical resistance, for example against water and many chemicals can be explained by the boron content of the glasses. The temperature resistance and the insensitiveness of the borosilicate glasses against abrupt fluctuations of temperature are the result of the low coefficient of thermal expansion of about 3.3×10⁻⁶ K⁻¹. Common borosilicate glasses are for example Duran®, Pyrex®, Ilmabon®, Simax®, Solidex® and Fiolax®. Furthermore, the binders according to the present invention have the advantage that they do not form gaseous crack products during the heat treatment which lead to the formation of pores in the matrix. This means that the inorganic binders according to the present invention are not part of reaction processes and, thus, no pores are formed. The used inorganic binder has the advantage that it closes pores which nevertheless might be formed, leading to the described high density, the impermeability to moisture and the exceptional corrosion resistance.

It is favorable that the inorganic binder is used in an amount of up to 40% by weight in the matrix. Further preferred, the inorganic binder is present in an amount of 10 to 30% by weight in the matrix and more preferably in an amount of 15 to 25% by weight in the matrix.

It has been shown that such a matrix is suitable to act as a corrosion barrier for an ultra-long time frame. In combination with the configuration of the waste compartments according to the present invention, the exceptional properties of the packages are obtained. In particular, the matrix is essentially free of pores and has a density, which is preferably in the range >99% of the theoretical density. It is important that the graphite matrix has a high density to prevent ingress of moisture into the package. This is guaranteed by the selection of materials on the one hand and by the method for production on the other hand.

The dissipation of decay heat of the radionuclides is remarkably improved by the embedment of the waste products in metal-encased form into the IGG-Matrix according to the present invention, which is due to the high thermal conductivity of the IGG-Matrix.

Basically, the waste products can have any imaginable shape. The waste products are preferably cylindrical in shape to achieve a good utilization of the package volume. This is especially true, if the waste package has the preferred form of a hexagonal prism. The packages preferably have a wrench size of 400 to 600 mm and a preferred height of 800 to 1200 mm.

210 waste compartments in the form of rods can be arranged with a trigonal 8-series design in such a hexagonal prism. One part thereof (5-10%) can be covered with absorber rods for neutron absorption. B₄C can be used as absorber material.

The IGG-Matrix can be produced by mixing the raw materials in powdered form, The press powder is preferably manufactured by mixing the graphite powder with the glass powder. The press powder may contain auxiliary excipients in amounts of several percent based on the total amount. These are for example auxiliary press materials, which may comprise alcohols.

The graphite powder is preferably used with a grain diameter of <30 μm. The remaining components preferably have nearly the same gain size like the graphite powder.

Preferably, a granulate is produced from the press powder. For producing a granulate, the raw materials, especially the two components, graphite powder and glass powder, are mixed together, compacted and subsequently crushed and sieved to form a granulate having a grain size of less than 3.14 mm and more than 0.31 mm.

From the granulate, a base body that is easy to handle and has recesses for receipt of metal-encased waste such as waste-containing composite-pressed rods or columns is pre-pressed. Pre-pressing is for example carried out in a four-column-press with three hydraulic drives. The press die is detached from the lower yoke of the press and is solely positioned by means of a centering stop.

For producing the recesses, forming rods that are composed of two parts are used according to the present invention:

A formative part of the rod with a higher diameter that is located on a thinner carrier rod.

Initially, a lower punch is moved upwards such that the required filling space is obtained up to the top edge of the die. A pre-dosed granulate portion is uniformly poured in, at first pre-pressed with the upper punch and then pushed down with the upper punch along with an unlocked lower punch such that the same filling space up to the top edge of the die is obtained. This procedure is repeated until the required length of the compacted briquette is obtained. As the required pressure for pushing is always below the pressure for pressurizing, it is possible to produce the pre-pressed base body over the whole length without density gradient. This is an important requirement to avoid any bending of the waste compartments during final pressing.

According to the present invention, both process steps, forming of a granulate and pre-pressing of the base body are carried out outside hot cells (remote operations).

The production of waste-containing HLW composite-pressed waste compartments is carried out in hot cells. Therefore, metal shells (preferably consisting of copper) are loaded with a preferably homogenous mixture of radioactive waste and glass as binder. After sealing the loaded shells, they are heated in an extrusion press and extruded to form composite-pressed waste compartments.

Such a modified procedure is also suitable for the production of waste packages with spent and not preprocessed nuclear fuel elements consisting of for example LWR and SWR (light water reactor and heavy water reactor).

As the rods of LWR have lengths of up to 4800 mm, they are first introduced into copper tubes, then formed to spiral-shaped bodies and subsequently embedded into the graphite-glass-matrix in layers.

Furthermore, the modified procedure is also suitable for safe ultimate disposal of irradiated graphite which is contaminated with radioisotopes from graphite-moderated nuclear power plants such as Magnox or AGR from UK, UNGG from France and RBMK from Russia.

The waste package according to the present invention is for example modeled on the Dragon-18-Pin-BE-design for high temperature reactors. The package is preferably a hexagonal prism having a wrench size of 500 mm and a height of 1000 mm. To decrease the temperature for final hot-pressing of the waste packages and, thus, to be able to use tools made of conventional steel as well as to abbreviate the press cycle (heating and cooling), a low melting borosilicate glass is preferably used as a binder and an aluminium-magnesium-alloy, especially AlMg1, is preferably used for the metal shells (cylinders) instead of cooper. As the decay heat is negligibly low compared with high-level radioactive waste, the diameter of the recesses for the cylinders loaded with irradiated graphite (1G) is increased to 80 mm, Accordingly, about 120 kg irradiated graphite can be embedded into the suggested waste package.

The invention comprises the method for producing a package for the storage of waste products with the steps: filling the waste products into a metal shell, compressing the waste products, assembling the one or more encased waste products with a mixture of graphite and glass, preferably in the form of a base body, to form a compacted briquette, final pressing of the compacted briquette to form a package.

According to this method, the waste products are preferably filled into the metal shell admixed with glass.

The compression of the waste products is preferably carried out by pressing. Preferred compression methods also comprise forging besides extrusion pressing and hot-isostatic pressing (HIP).

The invention also relates to a waste compartment comprising a mixture of at least one waste product with glass in a metal shell. Besides, this waste compartment has the properties of the waste compartments which are described above as part of the waste packages.

The use of a waste package described above for the storage of radioactive waste is also in accordance with the present invention.

### BRIEF DESCRIPTION OF THE DRAWINGS

FIG. 1 shows the package is a prism made of IGG-Matrix, which comprises the composite-pressed waste compartments in the form of rods encased with copper;

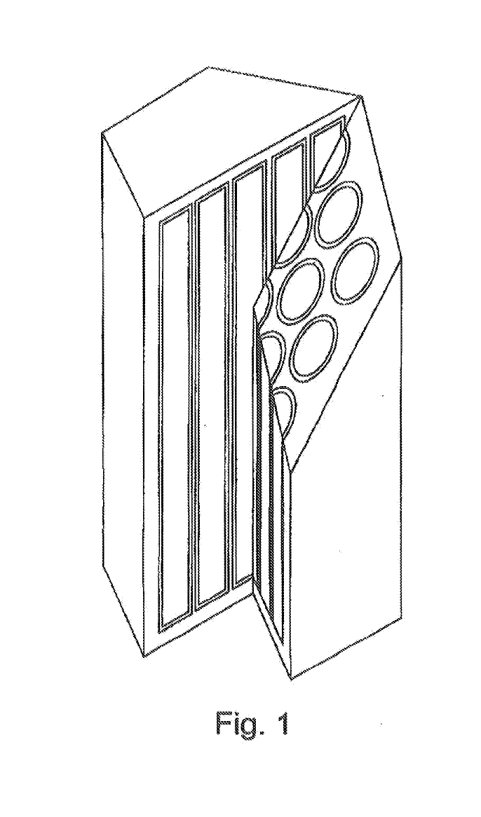

FIG. 2 shows the package is an IGG-Matrix base material including spent nuclear fuel elements that are not reprocessed, for ultra-long storage, fuel element will be pushed into tubular shells made of copper with a gap width of about 1 mm and embedded into the IGG-Matrix.

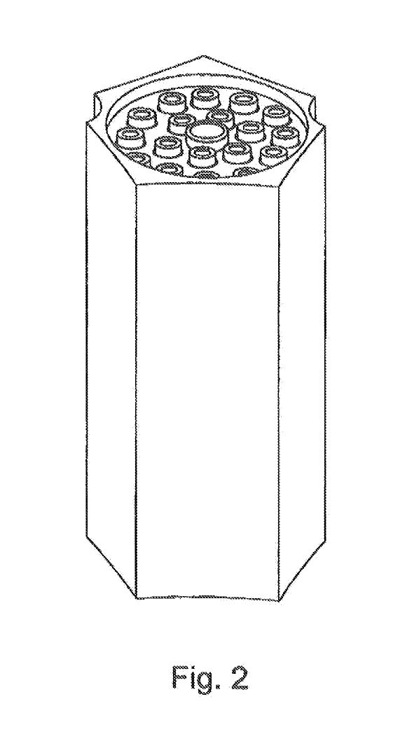

### DETAILED DESCRIPTION OF THE INVENTION

The following examples further illustrate the invention of waste packages and their production without limiting the scope of the invention.

### Example 1

### Design and Production of a Waste Package With HLW

The package is a prism made of IGG-Matrix, which comprises the composite-pressed waste compartments in the form of rods encased with copper.

Nuclear grade natural graphite having a grain diameter of less than 30 μm of the company Kropfmühl and a borosilicate glass having the same grain size with a melting point of about 1000° C. provided by the company Schott served as raw materials.

Both components were blended with, mass ratio of natural graphite to glass of 5:1 and pressed with the compactor Bepex L 200/50 P (company Hosokawa) to form briquettes, The density of the briquette was 1.9 g/cm³. A granulate having a grain size of less than 3.14 mm and more than 0.31 mm and a bulk density of about 1 g/cm³ was provided after subsequent crushing and sieving.

For producing the base body having recesses for receiving the rods, the pre-pressing was carried out in several subsequent steps. The diameter of the forming rods was 0.2 mm larger than the diameter of the carrier rods. The pressure was 40 MN/m² and the pushing pressure was less than 20 MN/m² during the whole briquette building process.

After the construction, the forming rods were drawn from the top and the carrier rods were removed by pulling them downwards.

For producing composite-pressed, waste-containing rods, the copper cylinders were loaded with a homogenous mixture of HLW-simulate in borosilicate powder. After sealing, the cylinders were heated in an extrusion press to 1000° C. and extruded to composite-pressed rods with a narrowing grade of 3. A density of about 90% of the theoretical density, based on the waste, was obtained in the rods.

After assembling the base body with the composite-pressed waste rods, it was heated to 1000° C. and processed for finalisation. The final pressing is a dynamic pressing. The briquette is moved at full load in the die alternately by the upper and the lower punch. After cooling down to 200° C., the briquette was ejected from the tool.

### Example 2

### Production of Waste Packages With Spent Nuclear Fuel Elements That are Not Reprocessed

For producing the packages, fuel element dummies were pushed into tubular metal shells made of copper with a gap width of about 1 mm. After sealing the rods, they were processed to composite-pressed, gap-free rods by means of extrusion at 1000° C. Subsequently, the rods are formed into spiral-shaped bodies and embedded into the glass-graphite-granulate analogous to the production of the base bodies. The final pressing of the waste packages is described in Example 1.

For characterization of the IGG-Matrix, specimens have been taken from the test-package in parallel (axial) and perpendicular (radial) to the pressing direction and their chemical and physical properties were determined. The results are presented in the following table:

density (g/cm³)

2.23 (99% of the theoretical density)

compressive strength (MN/m²)

| | |
|---|---|
| radial | 70 |
| axial | 52 |

bending strengths

| | |
|---|---|
| radial | 35 |
| axial | 26 |

linear thermal expansion (20-500° C. (μm/m K))

| | |
|---|---|
| radial | 9.2 |
| axial | 14.8 |

thermal conductivity (W/cm K)

| | |
|---|---|
| radial | 0.8 |
| axial | 0.4 |

The corrosion tests carried out in quinary carnallite basic solution at 95° C. (composition in % by weight: MgCl₂ 26.5, KCl 7,7, MgSO₄ 1.5, NaCl saturated, balance H₂O) gave a corrosion value of 1.1×10⁻⁴ g/m² d. Under this assumption, a penetration depth of less than 1.2 cm after about one million of years by surface corrosion has to he expected.

### Example 3

### Waste Package for Disposal of Irradiated and Contaminated Graphite (Irradiated Graphite, IG)

A basic body having 19 recesses with a diameter of 81 mm was produced from the graphite-glass-granulate analogous to Example 1 Subsequently, the hollow cylinders made of AlMg1-alloy were filed with a homogenous mixture of glass and IG-graphite. After loading the cylinders, they were sealed and rods having a diameter of 80 mm were formed by extrusion at 500° C. A density of the rods of 1.75 g/cm³ was obtained based on the IG-graphite in the matrix. After assembling the base body, the same was processed for finalisation analogous to Example 1.

All results match the measured values of the IGG-Matrix given in Example 1 except for the corrosion value which is two-times higher and has a value of 2.3 g/m²d.

1. A package comprising a matrix, wherein waste compartments are embedded into this matrix and that the matrix comprises graphite and an inorganic binder, wherein the binder is glass and wherein the portion of graphite in the matrix is at least 60% by weight.

2. The package according to claim 1, wherein the portion of graphite in the matrix is 60 to 90% by weight.

3. The package according to claim 1, wherein the inorganic binder has a melting point or softening point of less than 1500° C.

4. The package according to claim 1, wherein the waste compartments comprise waste products in a metal shell.

5. The package according to claim 4, wherein the waste compartments comprise the waste products in mixture with a binder, which is preferably glass.

6. The package according to claim 1, wherein the binder is borosilicate glass.

7. The package according to claim 1, wherein the inorganic binder is present in the matrix in an amount of up to 40% by weight.

8. A method for producing a package for the storage of waste products with the steps:
filling the waste products into a metal shell,
compressing the waste products,
assembling the one or more encased waste products with a mixture of graphite and glass, preferably in the form of a base body, to form a compacted briquette
final pressing of the compacted briquette to form a package.

9. The method according to claim 8, wherein the waste products are filled into the metal shell admixed with glass.

10. The method according to claim 8, wherein the base body is pre-pressed in layers.

11. The method according to claim 8, wherein the base body is designed such that it has recesses for receiving the encased waste products.

12. The method according to claim 8, wherein a density of 60 to 80% of the theoretical density is achieved by pre-pressing the base body.

13. The method according to claim 8, wherein compression is carried out by extrusion pressing, hot-isostatic pressing or forging.

14. The use of a package according to claim 1 for the storage of radioactive waste.
